(19) United States
(12) Patent Application Publication
(10) Pub. No.: US 2009/0011243 A1
(43) Pub. Date: Jan. 8, 2009

(54) METHOD FOR MANUFACTURING A DUST-PROOFING AND LIGHT-TRANSMITTING MEMBER, AND A DUST-PROOFING AND LIGHT-TRANSMITTING MEMBER, LOW-PASS FILTER, IMAGING DEVICE PROTECTOR, AND IMAGING APPARATUS

(75) Inventors: Kazuhiro YAMADA, Saitama (JP); Naohito SASAKI, Tokyo (JP); Hiroyuki NAKAYAMA, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/167,348

(22) Filed: Jul. 3, 2008

(30) Foreign Application Priority Data
Jul. 5, 2007 (JP) 2007-177655

(51) Int. Cl. B32B 3/00; B05D 5/06

(52) U.S. Cl. 428/409; 427/164

(57) ABSTRACT

A method for manufacturing a dust-proofing and light-transmitting member comprising the steps of forming a deposited coating and forming a dust-proofing coating is provided. The dust-proofing and light-transmitting member is arranged on a side of a light-receiving surface of an imaging device. The deposited coating is formed on a light-incident surface of a light-transmitting substrate. The deposited coating comprises aluminum, alumina, or a mixture of aluminum and alumina. The dust-proofing coating having fine roughness is formed on a surface by carrying out a hot water process for the deposited coating. Water warmed to between 40 and 100 degrees Celsius or a mixture of water and organic solvent is used in the hot water process.

### BACKGROUND OF THE INVENTION

1. Field of the Invention

The present invention relates to a manufacturing method of a dust-proofing and light-transmitting member, an optical low-pass filter, an imaging device protector, and an imaging apparatus having the member.

2. Description of the Related Art

Nowadays, electronic imaging apparatuses which convert an optical image into an electric signal, such as digital still cameras, facsimile machines, scanners, and so on, are widely used. If dust exists on an optical path of a light-receiving surface of an imaging device, such as a CCD in an electronic imaging apparatus, the dust will appear in the whole captured image.

For example, as for a digital still single-lens reflex camera with an interchangeable photographing lens, when the photographing lens is removed from the camera body, dust easily comes into the mirror box. In another situation, dust may be generated in the mirror box by the mechanism for controlling the mirror or a diaphragm of a photographing lens. For example, in the case of a facsimile machine or scanner, when a document is sent to a document image reader or the document image reader moves, dust may be generated. The generated dust may adhere to a light-receiving surface of the CCD or the platen glass. Although such dust is blown off by a blower, the blown dust remains in the mechanism.

In particular, an optical filter for controlling spatial frequency is located near the imaging device in a digital still camera. A quartz plate having birefringence is generally used as the optical filter. Quartz easily collects an electrical charge from vibration and the electrical charge is not easily released because quartz has a piezoelectric effect. Accordingly, dust floating in a camera due to air flow or vibration caused by some operation in the camera may adhere to an optical filter carrying an electrical charge. In order to take a clear photograph, frequent cleaning by an air blower is necessary.

To addressing this problem, Japanese Unexamined Patent Publication No. 2001-298640 discloses a digital still camera having a wiper which wipes an outside face of a dust-proofing mechanism. In addition, Japanese Unexamined Patent Publication Nos. 2002-204379 (U.S. Pub. No. US2004/012714) and 2003-319222 (U.S. Pub. Nos. US2003/202114 and US2007/296819) disclose a camera having a holder and a vibrator. The holder has an aperture. A CCD and an optical low-pass filter are mounted in the holder. The aperture is covered and sealed with a dust-proofing member. Dust does not adhere to the CCD and the optical low-pass filter in the holder. In addition, dust adhering to the dust-proofing member is removed by vibration produced by the vibrator. However, the mechanical removal of dust, as disclosed in the above publications has many problems, such as an increase of manufacturing cost, an increase of apparatus weight, an increase of power consumption, and so on.

### SUMMARY OF THE INVENTION

Therefore, an object of the present invention is to provide a dust-proofing and light-transmitting member which protects against dust, a manufacturing method of the member which maintains consistent quality, an optical low-pass filter, an imaging device protector, and an imaging apparatus comprising the member.

According to the present invention, a method for manufacturing a dust-proofing and light-transmitting member comprising the steps of forming a deposited coating and forming a dust-proofing coating is provided. The dust-proofing and light-transmitting member is arranged on a side of a light-receiving surface of an imaging device. The deposited coating is formed on a light-incident surface of a light-transmitting substrate. The deposited coating comprises aluminum, alumina, or a mixture of aluminum and alumina. The dust-proofing coating having fine roughness is formed on a surface by carrying out a hot water process for coating deposition. Water warmed to 40 and 100 degrees Celsius or a mixture of water and organic solvent is used in the hot water process.

Further, a base is added to the water in the hot water process.

Further, the thickness of the deposited coating ranges between 5 and 500 nm.

Further, the main component of the dust-proofing coating is alumina, hydroxide of aluminum, or a mixture of alumina and hydroxide of aluminum.

Further, the roughness of the dust-proofing coating comprises a lot of convex parts distributed irregularly, and concave parts. The convex parts are minute. The concave parts are grooves located between some of the convex parts.

Further, an anti-static coating is formed under the dust-proofing coating. Surface resistivity of the anti-static coating is less than or equal to 1×10¹⁴ Ω/square.

Further, a water-repellent coating or a water- and oil-repellent coating is formed as a surface layer of the dust-proofing and light-transmitting member. The thickness of the coating ranges between 0.4-100 nm.

Further, the three dimensional average surface roughness of a surface of the dust-proofing and light-transmitting member ranges between 1 and 100 nm.

### BRIEF DESCRIPTION OF THE DRAWINGS

The objects and advantages of the present invention will be better understood from the following description, with reference to the accompanying drawings in which:

FIG. 1 is a perspective view of one embodiment of the dust-proofing and light-transmitting member with a wiper;

FIG. 2A is a perspective view of one embodiment of the dust-proofing and light-transmitting member with a piezoelectric element;

FIG. 2B is a plan view of FIG. 2A;

FIG. 2C shows nodes of vibration of the dust-proofing and light-transmitting member shown in FIG. 2A;

FIG. 3A is a perspective view of another embodiment of the dust-proofing and light-transmitting member with a piezoelectric element;

FIG. 3B is a sectional view of a line connecting B-B in FIG. 3A;

FIG. 4 is a sectional view of a digital still camera having an optical low-pass filter having the dust-proofing and light-transmitting member of one embodiment;

FIG. 5 is a sectional view of a digital still camera having an optical low-pass filter having the dust-proofing and light-transmitting member of another embodiment;

FIG. 6 is a sectional view of a digital still camera having a protector 1 having the dust-proofing and light-transmitting member of one embodiment;

FIG. 7 is a sectional view of a digital still camera having a protector 1 having the dust-proofing and light-transmitting member of another embodiment;

FIG. 8 is an AFM image of the dust-proofing coating; and

FIG. 9 is a graph showing the spectral reflectance of the dust-proofing coating of the Examples 1-3.

### DESCRIPTION OF THE PREFERRED EMBODIMENTS

### [1] Light-Transmitting Substrate

A material for a light-transmitting substrate can be selected according to the purpose of a dust-proofing and light-transmitting member, and may be an inorganic compound or an organic polymer. For example, if the dust-proofing and light-transmitting member is used as an optical low-pass filter in an imaging device, the light-transmitting substrate is usually made of a quartz or vitreous silica, which has birefringence. In another case, if the dust-proofing and light-transmitting member is used as a protector for an imaging device or an optical low-pass filter, a light-transmitting substrate can be made of various kinds of inorganic glass or various kinds of transparent polymer. For example, the inorganic glass may be silica, borosilicate glass, or soda-lime glass. The transparent polymer may be a polymethacrylic acid ester resin, such as polymethyl methacrylate resin, or Polycarbonate resin. The shape and thickness of the light-transmitting substrate can be determined according to its purpose.

### [2] A Method for Manufacturing a Dust-Proofing and Light-Transmitting Member

A manufacturing method of a dust-proofing and light-transmitting member comprises a deposition process, a hot water process, and a drying process for forming a dust-proofing coating. In the deposition process, a deposited coating consisting essentially of aluminum, alumina, or a mixture of the two is formed on a light-incident surface of the light-transmitting substrate. In addition, the deposited coating may include another component. The hot water process is carried out on the deposited coating with water at a temperature between 40 and 100 degrees Celsius or a mixture of water and an organic solvent. In the drying process, the deposited coating having undergone the hot water process is dried. These processes are explained in detail later. In addition, if necessary, an anti-static coating may be formed before and/or after forming the dust-proofing coating. Furthermore, a water-repellent coating or a water- and oil-repellent coating may be formed as a surface layer of the dust-proofing and light-transmitting member.

### (1) Forming a Dust-Proofing Coating

### (a) Forming a Deposited Coating

The deposited coating consisting essentially of aluminum, alumina, or a mixture of the two is formed on the light-transmitting substrate using physical vapor deposition, such as a vacuum deposition method, a sputtering method, or an ion-plating method; or chemical vapor deposition (CVD), such as a thermal CVD method, a plasma CVD method, or an optical CVD method. The vacuum deposition method is preferable due to its economy. It is preferable that the thickness of the deposited coating be between 5 and 500 nm in order to form a homogeneous deposited coating and to finally form the dust-proofing coating with three dimensional average surface roughness is in a preferable range.

In the vacuum deposition method, the deposited coating is formed by condensing vapor of a first raw material, which is aluminum, alumina, or a mixture of the two, on the light-transmitting substrate in a high vacuum, such as 1×10⁻⁴-1×10⁻² Pa. The method of vaporizing the first material is not limited to a specified method. Any methods for vaporizing, for example, a method for vaporizing by an electric current heating source, or by applying an electron beam radiated from an E-type electron gun, or by applying a large current electron beam generated by hollow cathode discharge, or a laser ablation method, are applied. It is preferable to place the light-transmitting substrate so that the surface where the deposited coating is to be formed faces the first raw material and to rotate the light-transmitting substrate during the deposition process while keeping it facing the first raw material. A desired thickness of the formed deposited coating can be obtained by adjusting the duration of the deposition process.

An aluminum deposited coating is made of aluminum as the first material. In order to form a homogeneous aluminum deposited coating, deposition speed and a temperature are not limited but it is preferable that deposition speed be 1-10 nm/sec and the temperature of the light-transmitting substrate during the deposition process be 20-80 degrees Celsius.

An alumina deposited coating is formed according to a first or second method. In the first method, alumina is used as the first raw material. In the second method, aluminum is used as the first raw material and is reactively deposited by supplying a vacuum deposition apparatus with a little oxygen. In the first method, in order to form a homogeneous alumina deposited coating, deposition speed is not limited but it is preferable that deposition speed be between 0.1 and 1.0 nm/min and the temperature of the light-transmitting substrate during deposition process should be between 20 and 300 degrees Celsius. In the second method, it is preferable to supply oxygen at a pressure between 1×10⁻⁴ and 1×10⁻² Pa.

Among various CVDs, the plasma CVD, where a thin coating can be formed under low temperature, is preferable. In the plasma CVD, an aluminum deposited coating is formed by making plasma which is a source gas generate and promote a chemical reaction, such as decomposition, reduction, oxidation, substitution, and so on, on the surface of the light-transmitting substrate. For example, aluminum halide such as AlCl₃, organic aluminum such as Al(CH₃)₃, Al(i-C₄H₉)₃, and (CH₃)₂AlH, organic aluminum complex, aluminum alcoholate, and so on are preferred as the source gas. It is preferable that the source gas be supplied with to a substitute gas, such as helium, argon, and so on, to a surface of the light-transmitting substrate. Reactive gas, such as hydrogen, nitrogen, ammonia, nitrous oxide, oxide, carbon monoxide, methane, and so on, may also be mixed with the source gas.

### (b) Hot Water Process for the Deposited Coating

The hot water process is carried out on the deposited coating using hot water, of which temperature is 40-100 degrees Celsius, or mixture of water and an organic solvent. In the hot water process, it is preferable to immerse the light-transmitting substrate with the formed deposited coating in the hot water or the mixture. In addition, it is preferable that immersion temperature is 50-100 degrees Celsius. Furthermore, it is preferable to immerse the deposited coating in the hot water or the organic solvent for 1-240 minutes.

If necessary, a base may be added to the water. The dust-proofing coating will be formed quickly owing to the addition. Either an inorganic or organic base may be used. For example, amine is preferred as an organic base. For example, an alcoholamine such as monoethanolamine, diethanolamine, or triethanolamine, and an alkylamine such as methylamine, dimethylamine, trimethylamine, n-buthylamine, or n-propylamine are preferred as preferable amines. On the other hand, ammonia, sodium hydroxide, and potassium hydroxide are preferred as inorganic bases. The quantity of base added is not limited, however, 0.1 to 1 mass percentage relative to a 100 mass percentage for the sum of water and base is preferable.

In the case of the mixture of water and organic solvent, an alcohol, such as methanol, ethanol, propylalcohol, butylalcohol, etc., is preferable for the organic solvent. The quantity of organic solvent added is not limited as long as the effect resulting from this embodiment is not blocked.

Even if the deposited coating consists essentially of aluminum, alumina, or a mixture of the two, due to the hot water process for the deposited coating, roughness, comprising numerous convex parts having a minute irregular form and numerous concave parts such as grooves located between some of the convex parts, are formed on the surface of the deposited coating. The reason why such roughness is formed is unclear. However, the reason is guessed to be that the hot water process changes at least the surface of the deposited coating to a hydroxide of aluminum, such as boehmite, and that elution of the hydroxide of aluminum and deposition of the eluted hydroxide of aluminum coincide.

### (c) The Drying Process

It is preferable to dry the deposited coating having undergone the hot water process in the range of room temperature to 500 degrees Celsius after forming the roughness on the surface of the deposited coating. It is further preferable to heat for sintering at between 100 and 450 degrees Celsius. It is preferable that the drying or heating period be from 10 minutes to 36 hours long. By drying, the dust-proofing coating, having the roughness and made of alumina, hydroxide of aluminum, or a mixture of the two as main components, is formed. Even though the hot water process is carried out on the aluminum deposited coating, the main components of the dust-proofing coating will usually be alumina, hydroxide of aluminum, or a mixture of the two. Following the above method for manufacturing, the dust-proofing coating can be formed without a high temperature heating process. Accordingly, the dust-proofing coating can be formed on a plastic substrate having low heat resistance.

### (2) Forming an Anti-Static Coating

As described above, an anti-static coating may be formed inside and/or outside the dust-proofing coating. The anti-static coating further prevents dust from adhering to the surface of the dust-proofing coating. It is preferable to form the anti-static coating under the dust-proofing coating.

The anti-static coating is made of conductive inorganic material. Any generally known conductive inorganic materials can be adapted for use in the anti-static coating as long as the conductive inorganic material is colorless and highly transparent. For example, at least one material among a group consisting of antimony oxide, indium oxide, tin oxide, zinc oxide, indium tin oxide (ITO), and antimony tin oxide (ATO) preferably may be used as the conductive inorganic material. A dense coating consisting essentially of the conductive inorganic material mentioned above may be formed as the anti-static coating. Or, a composite coating consisting essentially of fine particles consisting essentially of the conductive inorganic material mentioned above, hereinafter referred to as a conductive inorganic particle, and a binder may be formed as the anti-static coating. A component of the binder, hereinafter referred to as binder component, is a monomer or an oligomer which works as a binder by polymerization. For example, metal alkoxide, an oligomer of the metal alkoxide, a UV-curable compound, or a thermosetting compound, such as acrylic ester, are preferred as binder components.

A coating consisting of conductive inorganic material can be formed by physical vapor deposition, such as a vacuum deposition method, or chemical vapor deposition, similar to the method for forming the deposited coating for dust-proofing coating explained above except for the use of a conductive inorganic material as raw material. The composite coating having conductive inorganic particles and a binder can be formed according to any common coating method, such as a dip coating method, a spin coating method, a spray method, a flow coating method, a roll coating method, a reverse coating method, a flexo printing method, a screen printing method, or a combination of these. The method for forming the composite coating having conductive inorganic particles and a binder according to various coating methods is explained below.

### (a) Preparation of Slurry Including Conductive Inorganic Particles

It is preferable that the average particle size of the conductive inorganic particles be about 5-80 nm. If the average particle size is more than 80 nm, transparency of the anti-static coating will be too low. On the other hand, it is difficult to prepare conductive inorganic particles of average particle size less than 5 nm.

It is preferable that the mass ratio of the conductive inorganic particles to the binder component be between 0.05 and 0.7. If the mass ratio is more than 0.7, it is difficult to homogeneously coat the composite coating and the formed composite coating will be too fragile. If the mass ratio is less than 0.05, the conductivity of the anti-static coating will be reduced.

Either metal alkoxide, an oligomer of the metal alkoxide, a UV-curable compound, or a thermosetting compound is preferable for the binder component. By using these materials, an anti-static coating including a binder can be formed even if the light-transmitting substrate does not have enough heat resistance.

A zirconium alkoxide such as zirconium tetra-methoxide or zirconium tetra-ethoxide, a titanium alkoxide such as tetramethoxy titanium or tetraethoxy titanium, and an aluminum alkoxide such as trimethoxy aluminum or triethoxy aluminum are preferable for the metal alkoxide of the binder component. A silane alkoxide such as methyl tri-alkoxy silane and tetra-alkoxy silane is even more preferable.

For example, a radical polymerizable compound, a cation polymerizable compound, and an anion polymerizable compound are preferred as a UV-curable compound or a thermosetting compound for the binder component. In addition, these compounds can be used together.

Acrylic acid or acrylic ester is preferable as the radical polymerizable compound. For example, (meth)acrylic acid, a monofunctional (meth)acrylate such as 2-hydroxyethyl (meth)acrylate and 2-hydroxypropyl (meth)acrylate, a di(meth)acrylate such as pentaerythritol di(meth)acrylate and ethylene glycol di(meth)acrylate, a tri(meth)acrylate such as trimethylol propane tri(meth)acrylate and pentaerythritol tri(meth)acrylate, a polyfunctional (meth)acrylate such as pentaerythritol tetra(meth)acrylate and di-pentaerythritol penta(meth)acrylate, and their oligomers are preferred as the acrylic acid or acrylic ester.

An epoxy compound is preferable as the cation polymerizable compound. For example, phenyl glycidyl ether, ethylene glycol diglycidyl ether, glycerin diglycidyl ether, vinyl cyclohexene dioxide, 1,2,8,9-diepoxy limonene, 3,4-epoxy cyclohexylymethyl 3′,4′-epoxy cyclohexane carboxylate, or bis(3,4-epoxy cyclohexyl) adipate are preferred as the epoxy compound.

If metal alkoxide is used as the binder component, water and a catalyst should be added to the slurry including the inorganic fine particles. For example, nitric acid, hydrochloric acid, sulfuric acid, phosphoric acid, acetic acid, and ammonia are preferred as the catalyst. It is preferable that the molar ratio of the added catalyst to the metal alkoxide be 0.0001-1. It is preferable that the mixing ratio of the metal alkoxide:solvent:water be 1:10-100:0.1-5.

If a radical polymerizable compound or cation polymerizable compound is used as the binder component, a radical polymerization initiator or a cation polymerization initiator should be added to the slurry including inorganic fine particles. A compound which generates a radical by receiving ultraviolet rays is used as the radical polymerization initiator. For example, benzyls, benzophenones, thioxanthones, benzyl dimethyl ketals, alpha-hydroxyalkyl phenones, hydroxyketones, amino alkylphenones, or acyl phosphine oxides are preferred as the radical polymerization initiator. The quantity of addition of the radical polymerization initiator is about 0.1-20 mass per 100 mass of the radical polymerizable compound.

A compound which generates a cation by receiving ultraviolet rays is used as the cation polymerization initiator. For example, an onium salt, such as a diazonium salt, a sulfonium salt, or an iodonium salt, is preferred as the cation polymerization initiator. The quantity of the cation polymerization initiator to be added should be about 0.1-20 parts by mass per 100 parts by mass of the cation polymerizable compound.

The inorganic fine particles and the binder component mixed into the slurry may be of more than two kinds. In addition, a general additive, such as dispersant, stabilizer, viscosity modifier, or a colorant, can be mixed into the slurry as long as the desired properties of the slurry are not deteriorated.

The density of the slurry influences the thickness of the anti-static coating to be formed. Alcohols such as methanol and ethanol, alkoxy alcohols such as 2-ethoxy ethanol and 2-buthoxy ethanol, ketols such as diacetone alcohol, ketones such as acetone and methyl ethyl ketone, aromatic hydrocarbons such as toluene and xylene, or esters such as ethyl acetate and butyl acetate are preferred as the solvent. The quantity of solvent is about 20-10,000 parts by mass per 100 parts by mass of the sum of the inorganic fine particles and the binder component.

### (b) Coating

Any common coating method, mentioned above, may be implemented for coating the slurry of the conductive inorganic particles. The dip coating method is preferred among them because homogenization of the coating and control of coating thickness are easy. For example, the coating thickness to be formed can be controlled by changing the lifting speed in the dip coating method or by changing the rotational speed of the base plate and the density of the coating fluid in the spin coating method. In the dip coating method, it is preferable that the lifting speed be about 0.1-3.0 mm/second.

The binder component in the slurry including conductive inorganic particles is made to be polymerized. If the binder component is metal alkoxide or their oligomer, the temperature required to cure the binder component is between 80 and 400 degrees Celsius and the period between 30 minutes and 10 hours. If the binder component is a UV-curable compound, the binder component is polymerized by applying ultraviolet rays of about 50-3,000 mj/cm² using a UV light source, and then a coating having conductive inorganic particles and a binder is formed. The time to apply the UV light will vary according to the thickness of the coating to be formed, however, it should be about 0.1-60 seconds.

The solvent of the slurry including conductive inorganic particles is made to be volatilized. In order to volatilize the solvent, the slurry may be kept at room temperature or heated to about 30-100 degrees Celsius.

### (3) Forming Water- and Oil-Repellent Coating

The water- and oil-repellent coating may be formed as the surface layer of the dust-proofing and light-transmitting member. Raw material to make the water- and oil-repellent coating is not especially limited to a specified material, and any generally known material which is colorless and highly transparent can be used for making the water- and oil repellent-material. For example, an inorganic fluorine compound and an organic and inorganic hybrid polymer including fluorine, an organic fluorine compound, a fluorinated pitch such as CFn, (n being 1.1-1.6), or graphite fluoride is preferred as the raw material to make the water- and oil-repellent coating.

One selected from a group consisting of Lif, MgF2, Caf2, AlF3, BaF2, YF3, LaF3, and CaF3 is preferred as the inorganic fluorine compound. These compounds can be obtained from, for example, Canon Optron Inc.

A copolymer of an unsaturated ester monomer including a fluoroaliphatic group and an unsaturated silane monomer, and an organic silicone polymer having fluorocarbon group are preferred as the organic and inorganic hybrid polymer including fluorine.

A copolymer of an unsaturated ester monomer including a fluoroaliphatic group represented by the following chemical formula (1) disclosed in Japanese Unexamined Patent Publication No. 2002-146271 (U.S. Pub. No. US2004/0028914) and an unsaturated silane monomer represented by the following chemical formula (2) is preferable.

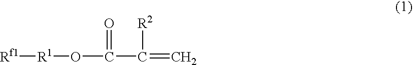

In the above chemical formula (1), R^{f1} is an aliphatic group at least partially fluorinated, R¹ is an alkylene group which may have another atomic group, and R² is hydrogen or a low alkyl group.

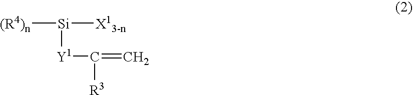

In the above chemical formula (2), R³ is hydrogen or a low alkyl group, R⁴ is hydrogen or a low alkyl group, X¹ is an alkoxy group, a halogen group, or —OC(═O)R⁵ group, R⁵ being hydrogen or a low alkyl group, Y1 is a single bond or —CH₂— group, and n is an integer ranging from 0-2.

A polymer prepared by hydrolysis of a silane compound having a fluorocarbon group is preferred as the organic silicone polymer having the fluorocarbon group. A compound represented by the following chemical formula (3) is preferred as the silane compound including fluorine.

CF₃(CF₂)ₐ(CH₂)₂SiR_{b}X_{c} (3)

In the above chemical formula (3), R is an alkyl group, X is an alkoxy group or halogen atom, a is an integer ranging from 0-7, b is an integer ranging from 0-2, c is an integer ranging from 1-3, and (b+C) is equal to 3. For example, CF₃(CH₂)₂Si(OCH₃)₃, CF₃(CH₂)₂SiCl₃, CF₃(CF₂)₅(CH₂)₂Si(OCH₃)₃, CF₃(CF₂)₅(CH₂)₂SiCl₃, CF₃(CF₂)₇(CH₂)₂Si(OCH₃)₃, CF₃(CF₂)₇(CH₂)₂SiCl₃, CF₃(CF₂)₇(CH₂)₂SiCH₃X(OCH₃)₂, and CF₃(CF₂)₇(CH₂)₂SiCH₃Cl₂ are preferred as the compound represented by the above chemical formula (3). An organic silicone polymer on the market, such as, XC-98-B2472 sold by GE Toshiba Silicone Co., Ltd., can be used as the organic and inorganic hybrid polymer including fluorine, mentioned above.

For example, fluorocarbon polymers are preferred as the organic fluorine compound. A polymer of olefin compounds including fluorine, and a copolymer of olefin compounds including fluorine and a monomer which can be copolymerized with them are preferred as the fluorocarbon polymers. As such polymer or copolymer, polytetrafluoroethylene, a tetraethylene-hexafluoropropylene copolymer, an ethylene-tetrafluoroethylene copolymer, a tetrafluoroethylene-perfluoroalkylvinylether copolymer, an ethylene-chlorotrifluoroethylene copolymer, a tetrafluoroethylene-hexafluoropropylene-perfluoroalkylvinylether copolymer, polychlorotrifluoroethylene, polyvinilydenefluoride, and polyvinylfluoride are preferred. A polymer of a fluorine compound on the market may be used as the fluorocarbon polymer. For example, OPSTAR sold by JSR Corporation and CYTOP sold by ASAHI GLASS Co., Ltd. are preferred as the fluorine compound.

### (a) A Method for Forming a Coating of an Inorganic Fluorine Compound

A coating consisting essentially of an inorganic fluorine compound can be formed by physical vapor deposition, such as a vacuum deposition method, or by chemical vapor deposition, similar to the method for forming the deposited coating for dust-proofing coating explained above except for the use of an inorganic fluorine compound as the raw material.

### (b) A Method for Forming a Coating of a Copolymer of an Unsaturated Ester Monomer Including a Fluoroaliphatic Group and an Unsaturated Silane Monomer

A coating of a copolymer of an unsaturated ester monomer including a fluoroaliphatic group and an unsaturated silane monomer may be formed according to a method of applying copolymer or a method of copolymerization. In the method of applying copolymer, at least both monomers are copolymerized, a solution including the synthesized copolymer is coated on the light-transmitting substrate, and the coated solution is dried. In the method of copolymerization, a solution including both monomers or their oligomers is coated on the light-transmitting substrate, the coated solution is dried, and they are copolymerized.

### (i) A Method of Applying Copolymer

The unsaturated ester monomer including a fluoroaliphatic group and an unsaturated silane monomer can be copolymerized according to a generally known method of radical polymerization. For example, a copolymer can be prepared by dissolving at least both monomers in an adequate solvent and heating the solution with a radical polymerization initiator, such as azobisisobutyronitrile, at 60-75 degrees Celsius for 10-20 hours. As the solvent, for example, a hydrofluoroether, such as C₃F₇OCH₃, C₃F₇OC₂H₅, C₄F₉OCH₃, or C₄F₉OC₂H₅, or a hydrofluorocarbon, such as CF₃CFHCFHCF₂CF₃ or C₅F₁₁H, are preferred.

A copolymer solution is prepared by dissolving the synthesized copolymer to the solvent or making the synthesized copolymer disperse in the solvent. As the solvent, for example, an easily volatile solvent, such as hydrofluoroether, hydrofluorocarbon, perfluoroether such as C₄F₉OCF₃ and C₄F₉OC₂F₅, linear fluorocarbon such as ethane trifluoride, C₆F₁₄, and C₇F₁₆, saturated hydrocarbon such as pentane, hexane, and heptane, ethers such as tetrahydrofuran, diethyl ether, and dioxane, ketones such as acetone, methyl ethyl ketone, methyl i-butyl ketone, and cyclohexane, and esthers such as ethyl acetate and butyl acetate, are preferred. Hydrofluoroether and perfluoroether are specially preferred.

It is also preferable that the density of the copolymer solution be 0.1-150 g/L, and 1-50 g/L is more preferable still. A commercially available copolymer solution may also be used. For example, Novec EGC-1700 and Novec EGC-1720 sold by Sumitomo 3M Ltd. are preferred as the commercially available copolymer solution.

Any common coating method, as mentioned above, may be implemented for applying the copolymer solution. The solvent is removed by drying after application. Common drying methods, such as air drying, heated air drying, and oven drying, may be implemented for drying the copolymer solution. If necessary, a vacuum drying method may be used. In the air drying method, for example, low humidity gas may be blown on the copolymer solution.

### (ii) A Method of Copolymerization

In the method of copolymerization, it is preferable to apply the monomer/oligomer solution to the light-transmitting substrate and to carry out radiation polymerization. Ultraviolet light, X rays, or an electron beam are preferable as the radiation. A method of the copolymerization using ultraviolet is explained below. The monomer/oligomer solution is prepared by dissolving a radical polymerization initiator and both monomers or their oligomers in the solvent or by dispersing a radical polymerization initiator and both monomers or their oligomers in the solvent. The same radical polymerization initiator and solvent as mentioned above may be used. It is preferable that the density of the monomer/oligomer solution be 0.1-150 g/L, and 1-50 g/L is even more preferable.

The monomer/oligomer solution may include a stabilizer such as acetonitrile, ureas, sulfoxide, or amide, a polymerization inhibitor such as hydroquinone monomethyl ether, etc., in addition to the components described above.

Any of the common coating methods, mentioned above, may be used for applying the monomer/oligomer solution. The solvent is removed by drying after application. The monomer/oligomer solution may be dried using the same drying method described above. The coated monomers or oligomers are polymerized by irradiating with ultraviolet light. The intensity of ultraviolet ray should be adjusted according to the kind of monomer, the thickness of the coated monomers or oligomers, and other factors. However, the intensity may be generally about 500-2,000 mJ/cm². An ultraviolet light source can be selected from among a low-pressure mercury-vapor lamp, a high-pressure mercury-vapor lamp, a xenon lamp, a super high-pressure mercury-vapor lamp, a fusion UV lamp, etc.

### (iii) Crosslinking

If necessary, the coating of a copolymer may be crosslinked. A method by emitting ionizing radiation, a method using a crosslinking agent, and a method by vulcanization are preferred as the method for crosslinking. Alpha rays, beta rays, gamma rays, etc. can be used as the ionizing radiation. A compound having more than two unsaturated bonds, such as butadiene and isoprene, is preferred as the crosslinking agent. The crosslinking agent should be added to a solution including both monomers before polymerization if the method of applying polymer is carried out. The crosslinking agent should be added to the monomer/oligomer solution if the method of polymerization is carried out.

### (c) A Method for Forming a Coating of an Organic Silicone Polymer Having a Fluorocarbon Group

A coating consisting essentially of a polymer prepared by hydrolysis of a silane compound including fluorine can be formed using the same method for forming a coating with metal alkoxide according to sol-gel processing except for the use of the compound represented by the above chemical formula (3) as a raw material.

### (d) A method for Forming a Coating of a Fluorocarbon Polymer

A coating of fluorocarbon polymer can be formed using the vacuum deposition method or a wet method such as a coating method. A method of forming a coating of fluorocarbon polymer using a coating method is explained below. A coating of a copolymer of a fluorocarbon polymer may be formed using a first or second coating method. In the first coating method, olefin compounds including fluorine, alone or in mixture, are polymerized or copolymerized, a solution including the synthesized polymer or copolymer is applied to the light-transmitting substrate, and the solution is dried. In the second coating method, a solution including either olefin compounds including fluorine or their oligomer is applied to the light-transmitting substrate, the applied solution is dried, and polymerized or copolymerized. The first coating method is the same as the method of applying polymer described above, except for the use of the olefin compounds including fluorine, their oligomer, or both of them as raw materials. The second coating method is the same as the method of copolymerization described above, except for using the olefin compounds including fluorine, their oligomer, or both of them as raw materials. However, if the olefin compounds including fluorine are thermosetting, it is preferable to heat the solution to between 100 and 140 degrees Celsius for about 30-60 minutes.

### (4) Another Treatment

Before forming the dust-proofing coating, the anti-static coating, and the water- and oil-repellent coating, a corona discharge treatment or a plasma treatment may be carried out on the light-transmitting substrate or the underlying coating the above-mentioned coating to be formed in order to remove adsorbed water and impurities and to activate the surface. Such treatments make each of the coatings adhere to each other strongly.

### [3] A Dust-Proofing and Light-Transmitting Member

### (1) A Dust-Proofing Coating

The dust-proofing coating formed by the method described above has alumina, aluminum hydroxide, or a mixture of the two as main components, and is colorless and highly transparent. It is preferable that the main component of the dust-proofing coating be alumina. It is even more preferable that the dust-proofing be made only of alumina. The dust-proofing coating has the surface roughness, comprising a lot of convex parts with a minute irregular form and a lot of concave parts like groove located between some of the convex parts. The roughness is generated when the surface of the deposited coating consisting of aluminum, alumina, or a mixture of the two is immersed in hot water.

The roughness of the dust-proofing coating can be checked by certain methods such as observation of the surface and a section with a scanning electron microscope, and by observation (especially oblique observation) of the surface utilizing an atomic force microscope. The thickness of the dust-proofing coating is not especially limited to a specified thickness, and may be chosen according to purpose. However, it is preferable that the thickness be 5-200 nm. The thickness includes the fine roughness.

The fine roughness is formed on the surface of the dust-proofing coating, as described above. Generally, the intermolecular force of a dust particle adhering to the dust-proofing coating is reduced in proportion to the three dimensional average surface roughness, hereinafter referred to as SRa, which is an index of the surface density of the fine roughness of the dust-proofing coating. In addition, the contact-charging adhesion force between a uniformly electrified spherical dust particle and the dust-proofing and light-transmitting member, hereinafter referred to as F₁, is generated by the difference of the chemical potentials and represented by the following formula (4),

$${F}_{1} = - \frac{π {ɛ}_{0} {V}_{C}^{2} {A}^{2} {k}^{2} {D}^{2}}{457 {( {z}_{0} + b )}^{8}} \qquad ( 4 )$$

where, ε₀ is the permittivity of free space, equal to 8.85×10⁻¹² (F/m); the V_{c} is the contact potential difference between the dust-proofing coating of the dust-proofing and the light-transmitting member and a dust particle; A is the Hamaker constant that is equivalent to van der Waals interaction; k is a coefficient equal to a sum of k1 (=(1−ν₁²)/E₁) and k2 (=(1−ν₂²)/E₂); ν₁ and ν₂ are Poisson ratios respectively of the dust-proofing coating of the dust-proofing and light-transmitting member and a dust particle; E₁ and E₂ are the Young's moduli of the dust-proofing coating and a dust particle, respectively; D is the dust particle size; Z₀ is the distance between the dust-proofing coating and the dust particle; and b is the SRa of the dust-proofing coating. It is clear from formula (4) that F₁ can be diminished by increasing the SRa of the dust-proofing coating.

Concretely, when the dust-proofing coating is made so that the SRa of the dust-proofing coating is more than or equal to 1 nm, the molecular force between dust particles adhering to the dust-proofing coating and the F1 is low. However, if the SRa of the dust-proofing coating is more than 100 nm, incident light is dispersed by the dust-proofing member. Light dispersion is unsuitable for an imaging apparatus. Consequently, it is preferable that the SRa of the dust-proofing coating range between 1-100 nm. More preferably, the SRa should range between 5-80 nm. Ideally, the SRa should range between 10-50 nm. The SRa is an index calculated by applying the center-line-average roughness, which is defined by JIS B0601 and measured in three dimensions using an atomic force microscope. The SRa is represented by the following formula (5),

$$SRa = \frac{1}{{S}_{0}} {\int }_{{Y}_{B}}^{{Y}_{T}} {\int }_{{X}_{L}}^{{X}_{R}} \vert F ( X , Y ) - {Z}_{0} \vert d X d Y \qquad ( 5 )$$

where, X and Y are the X and Y dimensions; X_{L} and X_{R} are both ends of a surface to be measured in the X dimension; Y_{B} and Y_{T} are both ends of the surface to be measured in the Y dimension; S₀ is the area of the surface to be measured assuming that the surface is flat, calculated as |X_{R}−X_{L}|×|Y_{T}−Y_{B}|; F(X,Y) is the height at each measured point (X,Y); and Z₀ is the average height of the surface to be measured.

The Hamaker constant in the above formula (4) is approximated by a refractive index function, and diminishes in proportion to the refractive index. Specifically, if the dust-proofing coating, a water-repellent coating, or a water- and oil-repellent coating is formed at the surface of the dust-proofing and light-transmitting member, it is preferable that the refractive index of the dust-proofing coating be less than or equal to 1.50. It is further preferable that the refractive index be less than or equal to 1.45. The maximum peak-to-valley value, hereinafter referred to as P-V, in the fine roughness of the dust-proofing coating is not limited, but preferably ranges between 5 and 1,000 nm. Furthermore, the maximum peak-to-valley value means the height difference between the highest peak and the lowest valley. It is even more preferable that the P-V range between 50 and 500 nm. In addition, ideally, the P-V should range between 100 and 300 nm. When the P-V is between 5 and 1,000 nm, the dust-proofing coating is produces the least glare. In addition, when the P-V is between 50 and 500 nm, the dust-proofing coating has high transmissibility. P-V may be measured by an atomic force microscope.

A specific surface area is not limited, but it is preferable that the specific surface area, hereinafter referred to as S_{R}, of the dust-proofing coating be greater than or equal to 1.05. It is even more preferable that the S_{R} be greater than or equal to 1.15. However, it is preferable that the S_{R} not be so large that light can not be dispersed on the surface. The S_{R} is calculated by the following formula (6),

S_{R}=S/S₀ (6)

where, S₀ is the area of the surface to be measured (assuming that the surface to be measured is flat), and S is calculated by the following method. The surface to be measured is divided into a lot of minute triangles with three data apexes. The vector product |a×b|, where a is a vector from a first data apex to a second data apex and b is a vector from the first data apex to a third data apex, is determined to be the area of the minute triangles. The S is calculated by summing the areas of all the minute triangles.

### (2) Anti-Static Coating

As described above, an anti-static coating is made of conductive inorganic materials. The anti-static coating lowers Coulomb's force, which is one of the causes of dust adhesion. Consequently, dust repellency is improved. The electrostatic attractive force between a uniformly electrified spherical dust particle and the dust-proofing and light-transmitting member, hereinafter referred to as F₂, is represented by the following formula (7),

$${F}_{2} = - \frac{1}{4 π {ɛ}_{0}} \cdot \frac{{q}_{1} {q}_{2}}{{r}^{2}} \qquad ( 7 )$$

where, q₁ and q₂ are the electrical charges of the dust-proofing coating and the dust particle, respectively; r is the radius of the dust particle; and ε₀ is the permittivity of free space, equal to 8.85×10⁻¹² (F/m). It is clear from the formula (7) that F₂ can be reduced by decreasing the electrical charges of the dust-proofing coating and the dust particle. Consequently, it is helpful to remove charge using an anti-static coating.

An electrostatic image force between a uniformly electrified spherical dust particle and the dust-proofing coating, hereinafter referred to as F₃, is represented by the following formula (8), and generated by the charge induced on the dust-proofing coating when the electrified dust particle approaches the dust-proofing coating which is not originally electrically charged.

$${F}_{3} = - \frac{1}{4 π {ɛ}_{0}} \cdot \frac{( ɛ - {ɛ}_{0} )}{( ɛ + {ɛ}_{0} )} \cdot \frac{{q}^{2}}{{( 2 r )}^{2}} \qquad ( 8 )$$

In formula (8), ε₀ is the permittivity of free space, equal to 8.85×10⁻¹² (F/m); ε is the permittivity of the dust-proofing coating; q is the electric charge of the dust particle, and r is the radius of the dust particle. The F₃ mostly depends on the polarizability of the dust particle. Consequently, F₃ can be lowered by removing the charge from the adhering dust particle with the anti-static coating.

It is preferable that surface resistivity of the anti-static coating be less than or equal to 1×10¹⁴ ohm/square. It is even more preferable that the surface resistivity be less than or equal to 1×10¹² ohm/square. The refractive index of the anti-static coating is not especially limited; however, reflection-proofing of the anti-static coating is improved by forming the anti-static coating so that the refractive index of the anti-static coating is roughly between those of the light-transmitting substrate and the dust-proofing coating. The thickness of the anti-static coating is not especially limited and may be chosen according to purpose, but it is preferable that the thickness range between 0.01 and 3 μm.

### (3) Water-Repellent Coating and Water- and Oil-Repellent Coating

As described above, the water- and oil-repellent coating is generally formed as a surface layer of the dust-proofing and light-transmitting member. The liquid bridge force, hereinafter referred to as F₄, between a spherical dust particle and the dust-proofing and light-transmitting member is represented by the following formula (9), and is the force of a liquid bridge generated by condensation of liquid around a contact point between the dust-proofing and light-transmitting member and the dust particle.

F₄=−2πγD (9)

In formula (9), γ is the surface tension of the liquid and D is the dust particle size. Consequently, lowering the adhesion of water or oil by forming the water- and oil-repellent coating on the dust-proofing coating enables lowering of the adhesion of the dust particle by the F₄ force.

Generally, contact angles of water at a rough surface and of a flat surface have a relationship represented by the following formula (10),

cos θ_{γ}=γ cos θ (10)

where, θ_{γ} is the contact angle at a rough surface, γ is the surface area multiplication factor, and θ is the contact angle at a flat surface. The surface area multiplication factor is generally more than one. Consequently, if the θ is less than 90 degrees, θ_{γ} is less than θ. On the other hand, if θ is more than 90 degrees, θ_{γ} is more than θ. Hydrophilicity of a hydrophilic surface increases when the area of the hydrophilic surface is increased by making its surface rough. On the other hand, water repellency of a water-repellent surface increases when the area of the water-repellent surface is increased by making its surface rough. By forming a water-repellent coating keeping the surface of the dust-proofing coating having with fine roughness rough, the dust-proofing and light-transmitting member can have high water repellency. If the water- and oil-repellent coating is formed as a surface layer, it is preferable that the SRa, the P-V, and the S_{R} of the surface layer be in the ranges described above.

It is preferable that the thickness of the water- and oil-repellent coating range between 0.4 and 100 nm. It is even more preferable that the thickness range between 10 and 80 nm. If the thickness is between 0.4 and 100 nm, the SRa, the P-V and S_{R} of the dust-proofing coating can be kept in the ranges described above. If a water- and oil-repellent coating of thickness 0.4-100 nm is formed as the surface layer, dust repellency is improved by lowering F₄ as well as the intermolecular force and F₁, taking advantage of fine roughness of the dust-proofing coating. If the thickness of the water- and oil-repellent coating is less than 0.4 nm, water and oil repellency will be insufficient and F₃ cannot decrease more than the expected repellency with materials such as fluorocarbon polymer. On the other hand, if the thickness of the water- and oil-repellent coating is more than 100 nm, dust repellency reduces because the fine roughness of the dust-proofing coating is smoothed. It is preferable that the refractive index of the water- and oil-repellent coating be less than or equal to 1.5. It is even more preferable that the index be less than or equal to 1.45.

### (4) Examples of Preferable Layer Composition of the Dust Proofing and Light-Transmitting Member

As preferable layer composition of the dust proofing and light-transmitting member, for example, the composition of the dust-proofing coating and the light-transmitting substrate, the composition of the dust-proofing coating, the anti-static coating, and the light-transmitting substrate, the composition of the water- and oil-repellent coating, the dust-proofing coating, the anti-static coating, and the light-transmitting substrate, the composition of the dust-proofing coating, the light-transmitting substrate, and the dust-proofing coating, the composition of the dust-proofing coating, the anti-static coating, the light-transmitting substrate, the anti-static coating, and the dust-proofing coating, and the composition of the water- and oil-repellent coating, the dust-proofing coating, the anti-static coating, the light-transmitting substrate, and the anti-static coating, the dust-proofing coating, and the water- and oil-repellent coating are preferred. However, the layer composition is not limited to these above.

### (5) Properties

It is preferable that the SRa of the surface layer of the dust-proofing and light-transmitting member in a preferred embodiment of this invention range between 1 and 100 nm. It is even more preferable that the SRa range between 8 and 80 nm. And it is especially preferable that the SRa range between 10 and 50 nm.

The dust-proofing coating having fine roughness on the surface described above lowers the intermolecular force and the F₁ of a dust particle adhering to the dust-proofing and light-transmitting member of this embodiment. Consequently, the dust-proofing and light-transmitting member of this embodiment will have good dust repellency. Accordingly, a dust-proofing mechanism is unnecessary. So, manufacturing cost can be reduced, total weight decreased, and power consumption saved. In particular, the dust-proofing and light-transmitting member having the anti-static coating has even better dust repellency because the F₂ and F₃ between a dust particle and the dust-proofing and light-transmitting member are low. In addition, the dust-proofing and light-transmitting member having the water- and oil-repellent coating as a surface layer has even better dust repellency, because the F₄ between a dust particle and the dust-proofing and light-transmitting member can be reduced.

Because the dust-proofing and light-transmitting member of this embodiment has the fine roughness of the dust-proofing coating, it has low glare. In fact, the spectral reflectance of the dust-proofing and light-transmitting member of this embodiment of visible rays of wavelengths between 380 and 780 nm, is usually less than or equal to 3%.

### [4] Dust-Proofing Mechanism

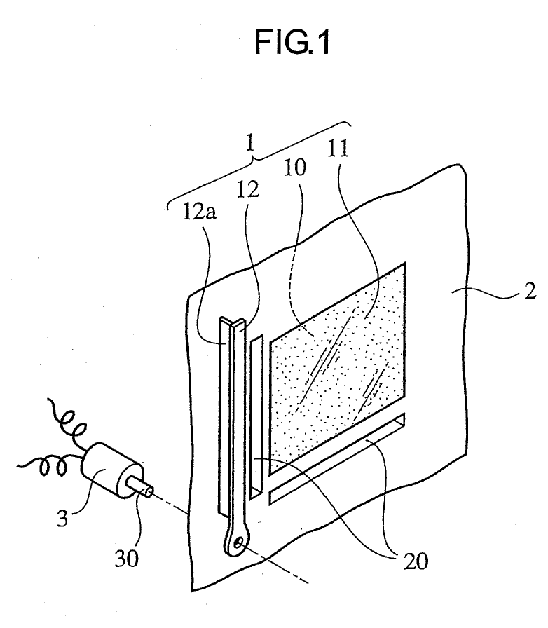

A dust-proofing mechanism which mechanically removes dust may be attached to the dust-proofing and light-transmitting member. A wiper and vibrator are preferred examples of dust-proofing mechanism. A piezoelectric element is an example of a preferred vibrator. FIG. 1 shows one embodiment of the dust-proofing and light-transmitting member with a wiper. In this embodiment, a rectangular dust-proofing and light-transmitting member 1 comprises a light-transmitting substrate 10, a dust-proofing coating 11, and a wiper 12. The dust-proofing coating 11 is formed on the light-transmitting substrate 10. The dust-proofing and light-transmitting member 1 is put in an aperture formed in a digital still camera body 2. The wiper 12 is supported near one corner of the rectangular dust-proofing and light-transmitting member 1 by a shaft 30 of a motor 3. When the wiper 12 is rotated by the motor 3, dust is swept by a wiper blade 12a and put into grooves 20 and 20 along the dust-proofing and light-transmitting member 1.

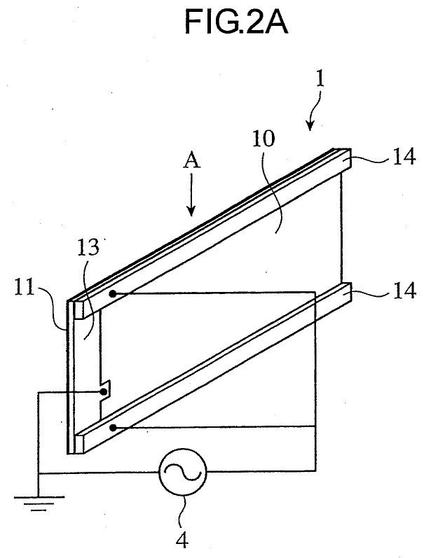

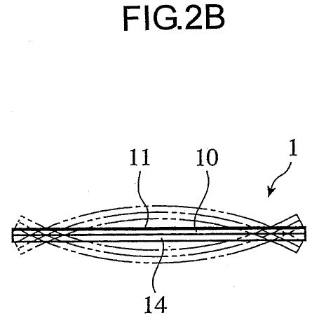

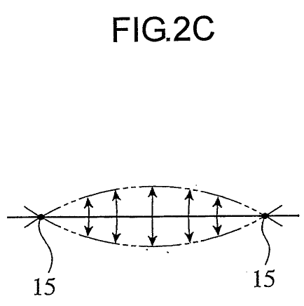

FIG. 2A shows one embodiment of the dust-proofing and light-transmitting member with a piezoelectric element. In this embodiment, a dust-proofing and light-transmitting member 1 comprises a light-transmitting substrate 10, a dust-proofing coating 11, an electric terminal 13, and piezoelectric elements 14. The dust-proofing coating 11 is formed on the light-transmitting substrate 10. The electric terminal 13 is mounted near a shorter side of the dust-proofing and light-transmitting member 1. The piezoelectric elements 14, formed in a stick shape, are mounted along both longer sides of the dust-proofing and light-transmitting member 1. The electric terminal 13 can be mounted by adhesion of a conductive material by gluing, vacuum deposition, plating, and other methods. The electric terminal 13 works as one electrode of both the piezoelectric elements 14 as well as an electrode for grounding. When both the piezoelectric elements 14 are expanded and contracted in the same cycle by ordering an oscillator 4 to apply periodic voltage to the piezoelectric elements 14, the dust-proofing and light-transmitting member 1 vibrates by bending, as shown in FIG. 2B. By making the dust-proofing and light-transmitting member 1 vibrate, as shown in FIG. 2C so that both ends of the longer sides of the dust-proofing and light-transmitting member 1 are nodes of the vibration, dust adhering to the dust-proofing and light-transmitting member 1 can be thrown in the optical axis direction perpendicular to the frontal surface of member 1 or moved to either of the longer end of the dust-proofing and light-transmitting member 1. The voltage and frequency applied may be determined according to the raw material of the light-transmitting substrate 10. In addition, by electrically connecting the dust-proofing and light-transmitting member to an imaging apparatus body through a ground wire as shown in FIG. 2A, electrification of the dust-proofing and light-transmitting member 1 can always be prevented.

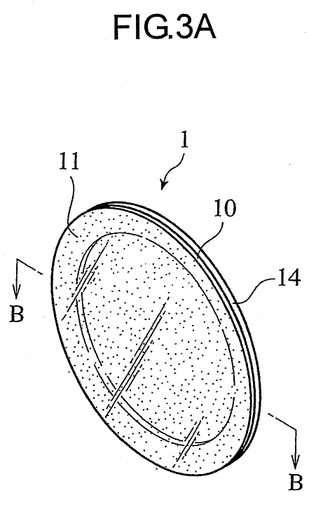

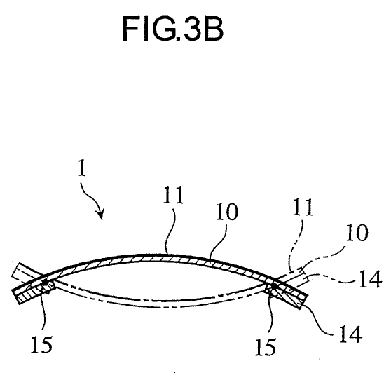

FIG. 3A shows another embodiment of the dust-proofing and light-transmitting member with a piezoelectric element. In this embodiment, a dust-proofing and light-transmitting substrate 1 comprises a round light-transmitting substrate 10, a dust-proofing coating 11, and a piezoelectric element 14. The dust-proofing coating 11 is formed on the light-transmitting substrate 10. The piezoelectric element 14 is formed as a ring plate shape, and mounted on the light-transmitting substrate 10. By ordering an oscillator (not depicted) to apply periodic voltage to the piezoelectric element 14, the dust-proofing and light-transmitting member 1 vibrates by bending, as shown in FIG. 3B. By making the dust-proofing and light-transmitting member 1 vibrate, dust can be moved to vibration nodes 15.

### [5] Imaging Apparatus

The dust-proofing and light-transmitting member described above is preferably adapted for an optical low-pass filter, a protector, and so on for an imaging device of an electronic imaging apparatus. The electronic imaging apparatus to which the dust-proofing and light-transmitting member of these embodiments can be applied for is not limited. For example, a digital still camera such as a digital still single-lens reflex camera, a digital video camera, a facsimile machine, a scanner, or any other image input apparatus are preferred as electronic imaging apparatuses to which the dust-proofing and light-transmitting member can be applied.

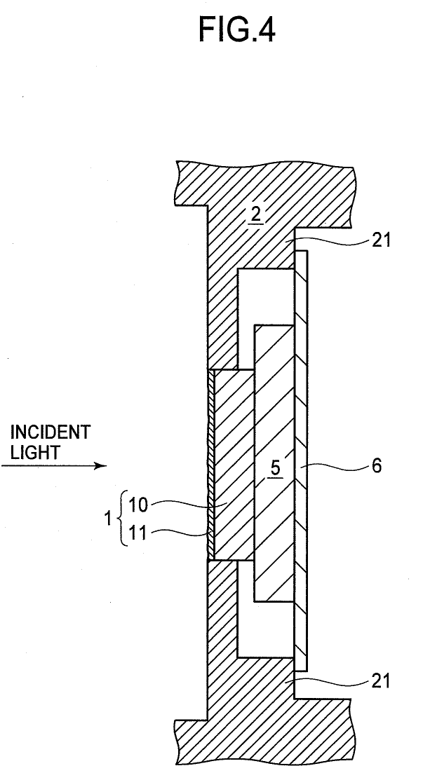

The dust-proofing and light-transmitting member is arranged on the side of a light receiving surface of an imaging device, such as a CCD or CMOS imaging device. FIG. 4 shows one embodiment of a digital still camera having an optical low-pass filter having the dust-proofing and light-transmitting member. In this embodiment, step-shaped block 21 is formed in camera body 2, a base plate 6 is supported by the step-shaped block 21, and CCD 5 is mounted on the base plate 6. An optical low-pass filter 1 having the dust-proofing coating 11 is put into the aperture of the camera body 2 and affixed tightly to the light receiving surface of the CCD 5.

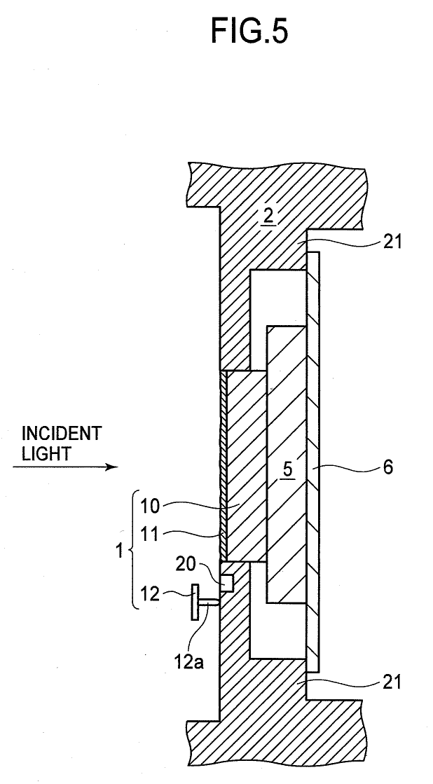

The digital still camera shown in FIG. 5 is the same as the one shown in FIG. 4 except for having a wiper 12. The dust removal function of the wiper 12 is described above. A sequential control and a circuit structure for driving the wiper 12 are not especially limited. For example, a sequential control and a circuit structure disclosed in Japanese Unexamined Patent Publication No. 2001-298640 may be applied.

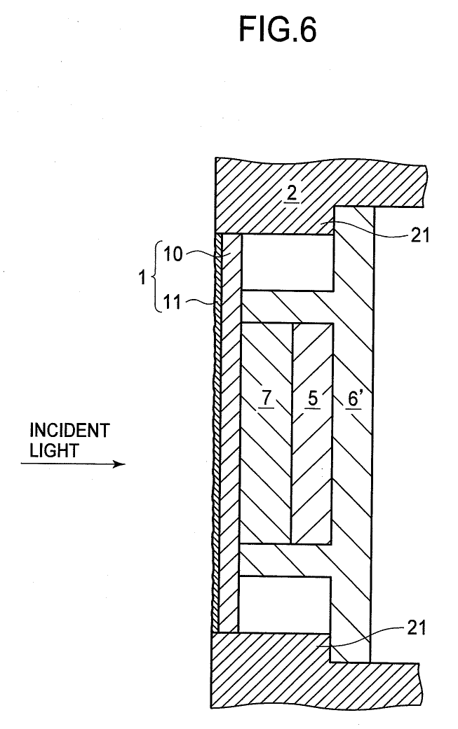

FIG. 6 shows one embodiment of a digital still camera having a protector 1 having the dust-proofing and light-transmitting member, comprising a light-transmitting substrate and a dust-proofing coating. In this embodiment, the dust-proofing coating 11 is formed on the light-transmitting substrate 10. A CCD 5 and an optical low-pass filter 7 are put in the bottom of the holder 6, which is formed as a box. The holder 6′ is supported by a step-shaped block 21 formed in camera body 2. The protector 1 is arranged on an aperture of the holder 6′.

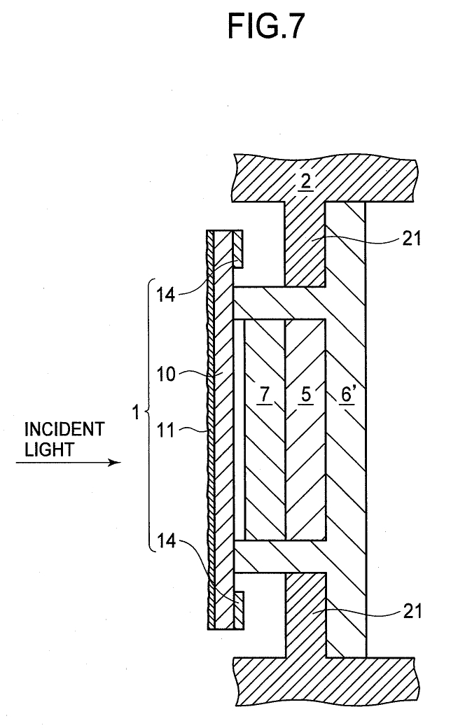

The digital still camera shown in FIG. 7 is the same as the one shown in FIG. 6 except for a piezoelectric element 14 mounted on the protector 1. The dust removal function of the vibration of the piezoelectric element 14 is described above. The circuit structure for driving the piezoelectric element 14 is not especially limited. For example, the circuit structure disclosed in Japanese patent publication Nos. 2002-204379 (U.S. Pub. No. US2004/012714) and 2003-319222 (U.S. Pub. Nos. US2003/202114 and US2007/296819) may be applied.

### EXAMPLES

This embodiment is explained in more detail below with reference to examples. However, this embodiment is not limited to these examples.

### Example 1

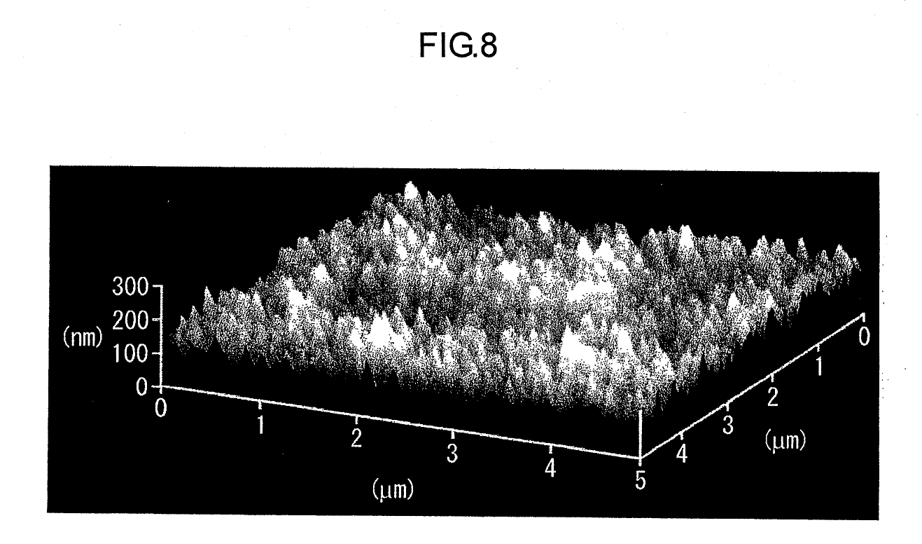

A flat substrate consisting essentially of quartz glass, of thickness, length, and width 1.8 mm, 22 mm, and 28 mm, respectively, was prepared. An aluminum coating of thickness 50 nm was formed on one surface of the prepared flat substrate warmed at 60 degrees Celsius by applying an electronic beam to aluminum put in a hearth liner made of boron nitride under initial pressure of 1.5×10⁻³ Pa in a vacuum deposition apparatus. The quartz glass plate with the aluminum coating was immersed in purified water warmed at 70 degrees Celsius for one hour. The deposited coating became transparent by the immersion process. After that, the coating was heated and dried at 400 degrees Celsius for one hour. Then, a dust-proofing coating having fine roughness was formed. By sticking an infrared-cut glass plate to the quartz glass plate having the dust-proofing coating, an optical low-pass filter with a dust-proofing coating on one surface was manufactured. The surface of the dust-proofing coating of the manufactured optical low-pass filter was observed with an atomic force microscope. An image by the AFM is shown in FIG. 8. Based on FIG. 8, it was ascertained that the dust-proofing coating had roughness comprising numerous, irregularly distributed convex parts with minute irregular shapes, and numerous concave parts like grooves located between some of the convex parts. The SRa of the formed dust-proofing coating of the optical low-pass filter was 30 nm.

### Example 2

An optical low-pass filter was manufactured using the same method as the Example 1 except that a flat plate composed of an infrared-cut glass layer and a quartz glass layer was used as a substrate, an aluminum coating was formed on a side of the quartz glass layer, and the coating was dried at 80 degrees Celsius for twenty-four hours. In addition, the thickness, length, and width of the substrate and the thickness of the aluminum coating were 1.8 mm, 22 mm, 28 mm, and 50 nm, respectively, as in Example 1. The SRa of the formed dust-proofing coating of the optical low-pass filter was 28 nm.

### Example 3

An ITO coating of which thickness and surface resistivity were 50 nm and 1×10⁴ ohm/m² was formed as an anti-static coating on a surface of the same quartz glass plate as the example 1 using the vacuum deposition method. An alumina coating of which thickness was 70 nm was formed at a deposition speed of 23 nm/minute on the ITO coating by warming the quartz glass plate having the ITO coating at 270 in a vacuum deposition apparatus, applying an electronic beam to aluminum put in a hearth liner made of boron nitride, and supplying oxygen so that pressure could be 4×10⁻³ Pa from 1.5×10⁻³ Pa of initial pressure in the vacuum deposition apparatus. The quartz glass plate with an alumina coating and an ITO coating was immersed in purified water warmed at 70 degrees Celsius for one hour. After the immersion process, a dust-proofing coating having fine roughness was formed by heating and drying the quartz glass plate at 400 degrees Celsius for one hour. An infrared-cut glass plate was stuck to the other surface than the surface where the dust-proofing coating and the anti-static coating were formed. Water- and oil-repellent coatings of 30 nm thickness were formed on both surfaces of the quartz glass plate having the coatings and infrared-cut glass plate by coating with a coating agent and drying at room temperature. In the coating process, the coating agent including an organic and inorganic hybrid polymer including fluorine of the Novec EGC 1720 brand manufactured by Sumitomo 3M Ltd., was applied using the dip coating method. An optical low-pass filter was manufactured by forming the water- and oil-repellent coatings. The SRa of the surface of the optical low-pass filter where dust-proofing coating was formed was 28 nm.

### Example 4

An optical low-pass filter was manufactured by the same method as the example 1 except for the use of water including 0.3 mass % of triethanolamine instead of purified water and immersing the quartz glass plate with the aluminum coating in water warmed at 60 degrees Celsius for one minute. The SRa of the formed dust-proofing coating of the optical low-pass filter was 23 nm.

### Comparative Example 1

An anti-reflection coating, having a layer composition of SiO₂, TiO₂, SiO₂, TiO₂, and SiO₂, and of which thickness is 0.3 μm, was formed by alternately depositing SiO₂ and TiO₂ on a quartz plate. A water-repellent coating of thickness 0.05 μm was formed on the anti-reflection coating using a water-repellent agent including fluorine, of the OF-110 brand manufactured by Canon Optron Inc., according to the resistive heating method. The SRa of the surface of the optical low-pass filter manufactured using the above processes was 0.4 nm.

Particle repellency of the optical low-pass filters of Examples 1-4 and Comparative Example 1 is measured according to the method described below.

### (1) Number of Particles Adhering to the Optical Low-Pass Filter

Each optical low-pass filter was set in a cylindrical vessel, of 1,000 cm³ capacity and 95 mm diameter with the optical low-pass filter standing upright. 0.1 mg of silica sand, of particle size ranging between 20 and 30 μm, was scattered in the cylindrical vessel. The main component of the scattered silica sand was SiO₂, and the density of the silica sand was 2.6 g/cm³. After silica sand is dispersed in the vessel and the vessel with the optical low-pass filter and silica sand was left to stand for one hour, the number of silica sand particle adhering to the optical low-pass filter was counted. The measurement above was held at 25 degrees Celsius and 50% relative humidity. The counted number is given in Table 1 below, along with corresponding SRa values.

TABLE 1

| | SRa of surface | Number of silica |
|---|---|---|
| | (nm) | sand particles |
| Example 1 | 30 | 1 |
| Example 2 | 28 | 2 |
| Example 3 | 14 | 6 |
| Example 4 | 23 | 8 |
| Comparative | 0.4 | 105 |
| Example 1 | | |

Since the optical low-pass filter of the examples 1-4 had a dust-proofing coating having fine roughness, the number of adhered silica sand particle was low. Consequently, adhesion of dust to the optical low-pass filter of the examples 1-4 was low. In particular, adhesion of dust to the optical low-pass filter of Example 3 was low because the optical low-pass filter had a water- and oil-repellent coating on the surface. On the other hand, the number of silica sand particle adhering to the optical low-pass filter without a dust-proofing coating of in Comparative Example 1 was much greater than in Examples 1-4. Thus, it was shown that adhesion of particles to the dust-proofing and light-transmitting member of these embodiments was effectively reduced.

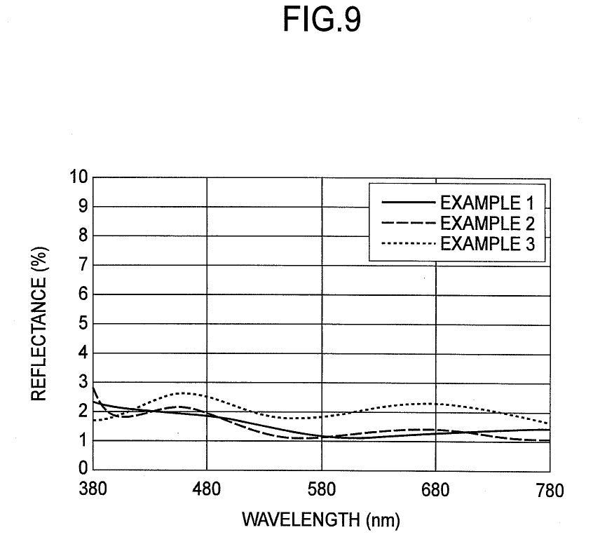

Spectral reflectances of the dust-proofing coatings of Examples 1 and 2, and of the water- and oil-repellent coating of Example 3 against light of wavelength ranging between 380 and 780 nm were measured by a model U400 spectrometer manufactured by Hitachi Ltd. The measured spectral reflectances are shown in FIG. 9. The spectral reflectances for all examples were less than or equal to 3%. Thus, it was shown that the optical low-pass filter of all examples had superior anti-reflection.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2007-177655 (filed on Jul. 5, 2007), which is expressly incorporated herein, by reference, in its entirety.

1. A method for manufacturing a dust-proofing and light-transmitting member, said dust-proofing and light-transmitting member being arranged on the light-receiving surface of an imaging device, said method comprising the steps of:
forming a deposited coating on a light-incident surface of a light-transmitting substrate, said deposited coating comprising aluminum, alumina, or a mixture of aluminum and alumina; and
forming a dust-proofing coating having fine roughness on a surface by carrying out a hot water process on said deposited coating, water warmed to between 40 and 100 degrees Celsius or a mixture of water and organic solvent being used in said hot water process.

2. A method according to claim 1, wherein a base is added to said water.

3. A method according to claim 2, wherein alcoholamine is used as said base.

4. A method according to claim 1, wherein the thickness of said deposited coating ranges between 5 and 500 nm.

5. A method according to claim 1, wherein a main component of said dust-proofing coating is alumina, hydroxide of aluminum, or a mixture of alumina and hydroxide of aluminum.

6. A method according to claim 1, wherein said roughness of said dust-proofing coating comprises numerous irregularly distributed minute convex parts and concave parts, and said concave parts are grooves located between some of the convex parts.

7. A method according to claim 1, wherein an anti-static coating is formed under said dust-proofing coating, and the surface resistivity of said anti-static coating is less than or equal to 1×10¹⁴ ohm/square.

8. A method according to claim 1, wherein a water-repellent coating or a water- and oil-repellent coating of thickness ranging between 0.4 and 100 nm is formed as a surface layer of said dust-proofing and light-transmitting member.

9. A method according to claim 1, wherein the three-dimensional average surface roughness of a surface of said dust-proofing and light-transmitting member ranges between 1 and 100 nm.

10. A dust-proofing and light-transmitting member manufactured according to a method comprising the steps of:
forming a deposited coating on a light-incident surface of a light-transmitting substrate, said deposited coating comprising aluminum, alumina, or a mixture of aluminum and alumina; and
forming a dust-proofing coating having fine roughness on a surface by carrying out a hot water process on said deposited coating, water warmed to between 40 and 100 degrees Celsius or a mixture of water and organic solvent being used in said hot water process.

11. A dust-proofing and light-transmitting member according to claim 10, wherein a dust-proofing mechanism is mounted to said dust-proofing and light-transmitting member.

12. An optical low-pass filter comprising a dust-proofing and light-transmitting member manufactured according to a method comprising the steps of:
forming a deposited coating on a light-incident surface of a light-transmitting substrate, said deposited coating comprising aluminum, alumina, or a mixture of aluminum and alumina; and
forming a dust-proofing coating having fine roughness on a surface by carrying out a hot water process on said deposited coating, water warmed to between 40 and 100 degrees Celsius or a mixture of water and organic solvent being used in said hot water process.

13. An imaging device protector comprising a dust-proofing and light-transmitting member manufactured according to a method comprising the steps of:
forming a deposited coating on a light-incident surface of a light-transmitting substrate, said deposited coating comprising aluminum, alumina, or a mixture of aluminum and alumina; and
forming a dust-proofing coating having fine roughness on a surface by carrying out a hot water process on said deposited coating, water warmed to between 40 and 100 degrees Celsius or a mixture of water and organic solvent being used in said hot water process.

14. An imaging apparatus comprising an optical low-pass filter comprising a dust-proofing and light-transmitting member manufactured according to a method comprising the steps of:
forming a deposited coating on a light-incident surface of a light-transmitting substrate, said deposited coating comprising, alumina, or a mixture of aluminum and alumina; and
forming a dust-proofing coating having fine roughness on a surface by carrying out a hot water process on said deposited coating, water warmed to between 40 and 100 degrees Celsius or a mixture of water and organic solvent being used in said hot water process.

15. An imaging device comprising an imaging device protector comprising a dust-proofing and light-transmitting member manufactured according to a method comprising the steps of:
forming a deposited coating on a light-incident surface of a light-transmitting substrate, said deposited coating comprising aluminum, alumina, or a mixture of aluminum and alumina; and
forming a dust-proofing coating having fine roughness on a surface by carrying out a hot water process on said deposited coating, water warmed to between 40 and 100 degrees Celsius or a mixture of water and organic solvent being used in said hot water process.
